(19) United States
(12) Patent Application Publication
(10) Pub. No.: US 2022/0377428 A1
(43) Pub. Date: Nov. 24, 2022

(54) ON DEMAND SHARED MEDIA STREAMING WITH LOCATIONAL AND TEMPORAL LIMITATIONS

(71) Applicant: TbirchHoldings Ltd., Cincinnati, OH (US)

(72) Inventors: Thompson Birch, Cincinnati, OH (US); Natnael Wallis, Clarksville, OH (US)

(21) Appl. No.: 17/748,720

(22) Filed: May 19, 2022

Related U.S. Application Data
(60) Provisional application No. 63/190,596, filed on May 19, 2021.

(51) Int. Cl. H04N 21/472; H04N 21/258; H04N 21/439

(52) U.S. Cl. CPC H04N 21/47202; H04N 21/25841; H04N 21/4396

(57) ABSTRACT

A shared media streaming system is configured to allow audience members of a movie screening or other live event to view that event via a user device such as a personal smartphone if they exit the area of the live event to visit a concession area or restroom. The shared media stream begins displaying the film on the user device starting at the same moment that the request to stream was made so that the user may leave and return to the screening room without missing substantial portions of the film, and without re-watching already viewed portions of the film. Viewing is limited to particular geofenced areas within a theater, and is limited in time so that users must return to the screening room if they wish to continue watching the film beyond the limited time. Other limitations are also enforced to prevent misuse of the system.

### PRIORITY

This application claims the priority of U.S. Provisional Pat. App. 63/190,596, filed May 19, 2021, and titled “On Demand Shared Media Streaming with Locational and Temporal Limitations,” the entire disclosure of which is incorporated by reference herein.

### FIELD

The disclosed technology pertains to a system for on demand limited media streaming.

### BACKGROUND

While the quality and availability of options for viewing recent cinema releases outside of a theater has improved somewhat over time, the shared experience of viewing a film with an audience is still an important social custom and commercial market. With most theaters shuttered for a year or more due to pandemic risks, a number of major film releases were instead made available to home audiences over subscription streaming services. At the same time, many major releases were indefinitely delayed, with their respective studios intent on an in-theater release even if it meant wasted marketing energy and a risk of losing the interest of potential audiences.

The long term implication seems to be that theater releases will still be a studio's primary focus, especially for blockbuster films. However, this intention is at odds with a general trend across entertainment, including cinema, major sports events, and concerts; consumers increasingly prefer to view events from the comfort of their home. Increasingly affordable home cinema equipment, the convenience of viewing an event without leaving the home, and the flexibility to take a refreshment break while pausing a show has left many audiences feeling that a trip to the theater is an uncomfortable and inconvenient experience.

What is needed, therefore, is an improved system for on demand limited media streaming.

### BRIEF DESCRIPTION OF THE DRAWINGS

The drawings and detailed description that follow are intended to be merely illustrative and are not intended to limit the scope of the invention as contemplated by the inventors.

FIG. 1 is a schematic diagram of an exemplary system configured to provide on demand shared media streaming;

FIG. 2 is an illustration of an exemplary user experience for a shared media streaming system;

FIG. 3 is a schematic diagram illustrating a theater with exemplary configured zones where shared media streaming is allowed;

FIG. 4 a flowchart of an exemplary set of high-level steps that could be performed with a system such as that of FIG. 1 to provide shared media streaming with enforced limitations;

FIG. 5 is a flowchart of an exemplary set of steps that could be performed with a system such as that of FIG. 1 to configure an on demand media streaming system for use;

FIG. 6 is a flowchart of an exemplary set of steps that could be performed with a system such as that of FIG. 1 to receive and validate requests for media streams;

FIG. 7 is a flowchart of an exemplary set of steps that could be performed with a system such as that of FIG. 1 to provide media streams in response to requests;

FIG. 8 is a flowchart of an exemplary set of steps that could be performed with a system such as that of FIG. 1 to enforce limitations for allocated streams;

FIG. 9 is a flowchart of an exemplary set of steps that could be performed with a system such as that of FIG. 1 to validate a user device location during enforcement of limitations; and

FIG. 10 is a flowchart of an exemplary set of steps that could be performed with a system such as that of FIG. 1 to revoke and close allocated streams.

### DETAILED DESCRIPTION

The inventor(s) have conceived of novel technology that, for the purpose of illustration, is disclosed herein as applied in the context of on demand limited media streaming. While the disclosed applications of the inventors' technology satisfy a long-felt but unmet need in the art of on demand limited media streaming, it should be understood that the inventors' technology is not limited to being implemented in the precise manners set forth herein, but could be implemented in other manners without undue experimentation by those of ordinary skill in the art in light of this disclosure. Accordingly, the examples set forth herein should be understood as being illustrative only, and should not be treated as limiting.

The comfort and convenience of theater viewing experiences is at odds with audiences increasing expectations for the same. While some theaters provide an upscale viewing experience with premium seating, in-theater dining and drink service, and other perks a number of significant inconveniences still exist. In particular, audiences know that once a film begins they must remain in the screening room to avoid missing any part of a film. The same is also true of sporting events and other live events; if you leave your seat for whatever reason, the show goes on and you miss out. This inconvenience is an additional friction that may prevent a potential audience from attending a live screening, or may negatively influence their activities in other ways.

For example, it is not uncommon for recent blockbuster films to have a viewing time of nearly three hours. Knowing this, many audience members will forego purchasing drinks and other refreshments to enjoy during their viewing experience due to a fear that they will need to exit the screening room for one or several restroom breaks during the film, never knowing whether they've picked a good time to exit the screening room or whether a critical scene is moments away. Other audience members may take the risk, and may spend lengthy periods of time in discomfort hoping that the film will soon end. Regardless of the approach or outcome, it leaves a negative impression for the entire experience, and may negatively impact concession sales and future attendance.

The disclosed technology for on demand shared media streaming, which may be referred to herein simply as shared media streaming, addresses these issue by giving audience members a limited capability to view portions of a currently screened film via a user device such as a smartphone so that they may exit the screening room to purchase refreshments, make an important telephone call, visit a restroom or other facility, or take care of some other issue that cannot be addressed inside the screening room. This shared media streaming may be provided with a number of limitations in order to ensure that other audience members or movie goers are not negatively impacted by a shared media stream, to ensure that a movie studio's rights and the theater's rights are protected, and to prevent other abuses of the system. Such limitations may include, for example, spatial limitations to restrict shared media streaming to certain locations within or near the theater, and temporal limitations to restrict the length of time that shared media streaming can be viewed, as well as other limitations as will be described in more detail below.

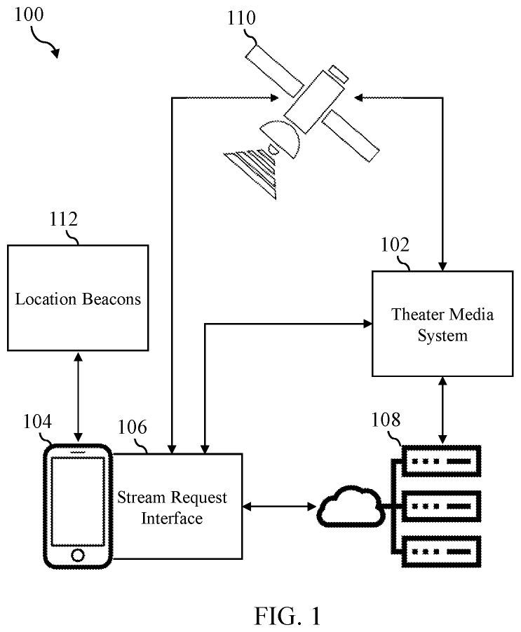

Turning now to the figures, FIG. 1 is a schematic diagram of a system (100) configured to provide on demand shared media streaming. The system includes a theater media system (102) that may include computers, computer servers, storage devices, local communication networks (e.g., wired and/or wireless communication networks), and other components. The theater media system (102) may be configured to receive film media from distributors, store that film media, manage the licenses and rights to that film media, and distribute that film media to projectors for individual screens (e.g., via a wireless network or wired connection to a projection system) at times that screenings are scheduled. The theater media system (102) may receive film media in various ways, which may include via a transmission from a satellite (110), via download over the internet from a storage location, or via a physical storage device delivered to the theater, for example.

The system (100) also includes a stream request server (108) that may be in communication with the theater media system (102), and that is configured to store and maintain records relating to users of the system (100), including both theater users and audience users, and to store and maintain records relating to shared media streaming requests, allocations, and revocations, as will be described in more detail below. The stream request server (108) may include one or more servers, which may include physical servers, cloud servers, virtual servers or other server environments. Each server as well as the computers or servers of the theater media system (102) may include components such as a processor and memory, communication devices, storage devices, and other components as will be apparent to those of ordinary skill in the art in light of this disclosure.

A user device (104) may be a smartphone, tablet, proprietary computing device provide by the theater, or other computing device, and will typically be a handheld computing device, in each case having components such as a user interface (e.g., a keyboard or touch sensitive display), a display, a communication device (e.g., a Wi-Fi and/or cellular data network transceiver), a processor and memory, and other components as will be apparent to those of ordinary skill in the art in light of this disclosure. Each user device (104) may be configured with a stream request interface (106), which may be a software application installed on the device or accesses through the device, and which may be configured to provide a graphical interface for the user to interact with in order to request shared media streams, view shared media streams, and receive information related to shared media streams. As an example, the stream request interface (106) may be a native software application for a platform such as iOS or Android, and may be installed on the user device (104) and used to register as a user of the system (100), request shared media streams while attending a live screening, and view shared media streams after exiting a screening room for that live screening.

In varying implementations, the user device (104) may be in communication with one or more of the stream request server (108), the theater media system (102), the satellite (110), or other systems or networks of a media distributor that may be usable to receive film media. In some implementations, the user device (104) may communicate with the stream request server (108) over the internet to verify user information, verify stream allocation and revocation, and to communicate other information. In some implementations, the user device (104) may also receive shared media streams from the stream request server (108) in the form of data transmitted over the internet. In some implementations, the user device (104) may receive shared media streams from the theater media system as data transmitted over a local network or other network, such as where the user device (104) is connected to a local Wi-Fi network provided by the theater media system (102) so that data may be transmitted wirelessly over the local network to user devices (104) located within a communicable proximity of the theater media system (102). In some implementations, the user device (104) may receive shared media streams from the satellite (110) as wirelessly transmitted encoded data, similar to the manner that the theater media system (102) receives such data from the satellite (110), or may receive shared media streams in another manner directly from the distributor (e.g., via the internet or from the cloud).

In some implementations, the system (100) may also include one or more location beacons (112) or other external location and positioning devices that may be distributed about a theater building to aid in determining the location of a particular user device (104) relative to that theater building. Location beacons (112) may be, for example, passive or active wireless tags (e.g., RFID tags), wireless transceiver beacons or devices (e.g., Bluetooth beacons, Wi-Fi nodes), optical codes that may be placed at a location and scanned by an optical reader of a user device (104), and other examples. As will be described in more detail below, location beacons (112) may be used in addition to, or as an alternative to, other location determination devices and methods.

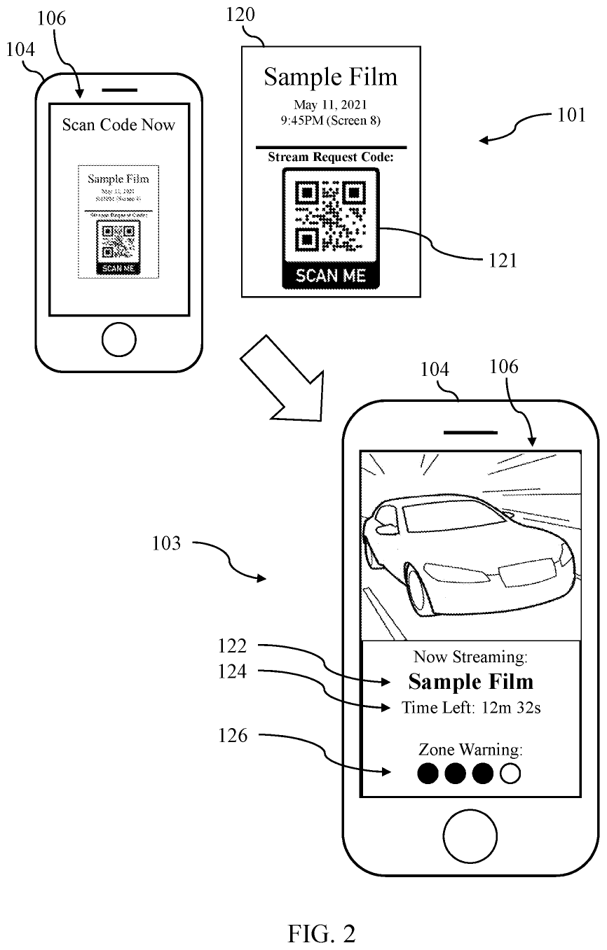

FIG. 2 is an illustration of an exemplary user experience for a shared media streaming system such as the system (100) described above. At a first stage (101), the user device (104) is shown displaying an interface of the stream request interface (106) that prompts the user to “Scan Code Now” and that activates the user device (104) camera or other scanning device to capture images. A ticket (120) provided to the user upon entry to the film screening includes information about the film being screened, and may also include an optical code (121) that may be scanned by the user device (104) when prompted by the stream request interface (106). When scanned, the optical code (121) will provide information to the user device (104), which may include one or more unique identifiers associated with the user's account and the film that the user is viewing. Such information may be directly encoded by the optical code (121), or may be accessible from a web address and/or authentication information encoded by the optical code (121), as will be apparent to those of ordinary skill in the art in light of the disclosure herein.

While FIG. 2 illustrates the optical code (121) being scanned from a physical ticket (120), it should also be understood that in some implementations the ticket (120) may instead be a digital ticket or token provided to the user device (104), and in such cases the information of the optical code (121) may already be present on or available to the user device (104), and so may not require optical scanning of an optical code or otherwise. In further implementations, the optical code (121) may instead be a wireless tag, such as an RFID tag, that the user device (104) may interact with via a tag transceiver in order to read information stored by the tag.

In a second stage (103) of FIG. 2, after the user has requested a shared media stream and scanned, read, or otherwise obtained the unique identifying information that the system (100) uses to validate the user and request, the stream request interface (106) then begins to display the shared media stream via the user device (104). The shared media stream will begin at substantially the same moment within the film media screening at which the live screening is at, allowing the user to be absent from the screening room while still viewing substantially the same portions of film media as that shown by the live screening. While displaying a shared media stream, the interface (106) may provide additional information related to the shared media stream, such as a title (122) or other information related to the film media, a time limit (124) remaining for which the shared media stream is available, and a zone indicator (126) that indicates whether the user device (104) is in an area where shared media streaming is allowed, and that may indicate the user device's (104) current proximity to an area in which shared media streaming is disallowed.

The time limit (124) may be a configured duration of time that represents the maximum amount of time that the film media may be viewed via the user device (104) before the user must return to the screening room in order to avoid missing any of the film, and may be configured and determined in varying ways as will be described in more detail below. The zone indicator (126) may visually indicate (e.g., by color, a bar, a series of symbols, or otherwise) whether the shared media stream is in danger of being revoked due to the user device (104) being located in an area where shared media stream are disallowed. In FIG. 2, the zone indicator (126) is shown as a set of filled or empty circles, which may change as the user reaches the edge of a geofenced area or other configured area in which viewing is allowed (e.g., circles may empty as the user approaches the edge of the area), or may begin to change after a user exits an area in which viewing is allowed (e.g., the circles may empty over a period of time, such as thirty seconds, while the user is outside of the allowed area to indicate to the user that they must return to the area before the shared media stream is revoked).

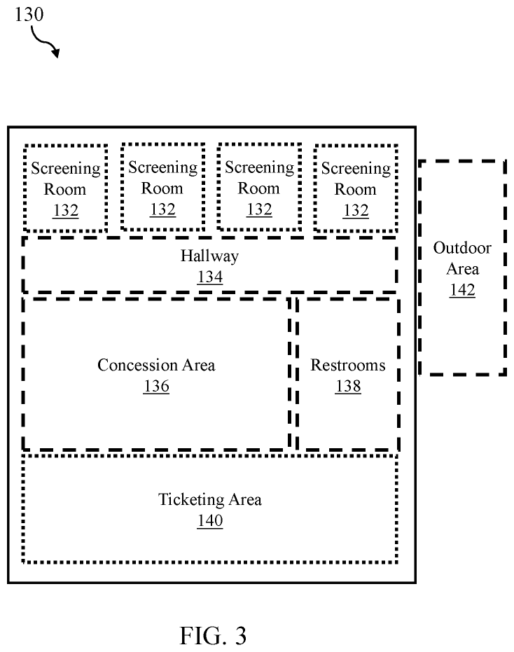

As has been described, enforcement of location limitations on shared media streams may be based on configured geofencing, which may include configuring areas to prevent or allow shared media streaming based on externally provided location data (e.g., such as that provided by a GPS receiver of a user device (104)) and/or locally provided location data, which may include interactions with location beacons (112), and information from local sensors of the user device (104). As an illustration, FIG. 3 shows a top down view of a theater (130) with a number of geofenced zones where shared media streaming is allowed, shown as dashed-lines, and geofenced zones where shared media streaming is disallowed, shown as dotted-lines. A ticketing area (140) where viewers first arrive and purchase tickets may be disallowed to prevent users of the system (100) from displaying shared media streams to those waiting in line. A concession area (136) and restrooms (138) may be allowed, to give users of the system (100) the flexibility to visit those areas while viewing the shared media stream. A hallway (134) that connects the screening rooms (132) to the concession area (136) and restrooms (138) may also be allowed, so that shared media streaming can begin the moment that the user exits the screening room (132). An outdoor area (142) accessible from the hallway (134) may also be allowed so that users may briefly exit the theater building (130) if needed, though the outdoor area (142) may be limited in size (e.g., within about 50 feet of the entrance to the hallway (134)). The individual screening rooms (132) may all be disallowed, to prevent shared media streams being viewed on a user deice (104) from disturbing other audience members that are still within screening rooms (132).

When properly configured, a user may request a shared media stream from within the screening room (132) and, once available, may be prompted via the user device (104) to exit the screening room (132). As they enter the hallway (134) the shared media stream will begin playing as illustrated by FIG. 2, and they may freely move to other allowed areas, subject to additional enforced limitations as will be described below, while viewing the shared media stream. If the user enters a disallowed area the shared media stream may immediately cease displaying, or may cease after a brief warning period. Determination of the user device's (104) location within the theater (130) to enforce configured geofencing may include using one or more of GPS positioning, location beacon (112) positioning, Wi-Fi network positioning, or positioning using sensors locally available to the user device (104) (e.g., accelerometers, imaging devices, audio capture devices). As an example, each allowed and disallowed area may be associated with a set of GPS locations that may be reported by the user device (104). As another example, each screening room (132) may include one or more location beacons (102) situated near the entrance(s) to that screen room, and that are configured to interact with user devices (104) that move nearby to determine the direction of movement (e.g., based upon a time-sequence of communications with the user device (104), a set of two or more location beacons (112) may indicate whether the user device (104) is entering or exiting the screening room (132)). The shared media stream may also be ceased voluntarily by interacting with the user device (104), or may cease automatically due to expiration of a configured time limit, or other scenarios, as will be described in more detail below.

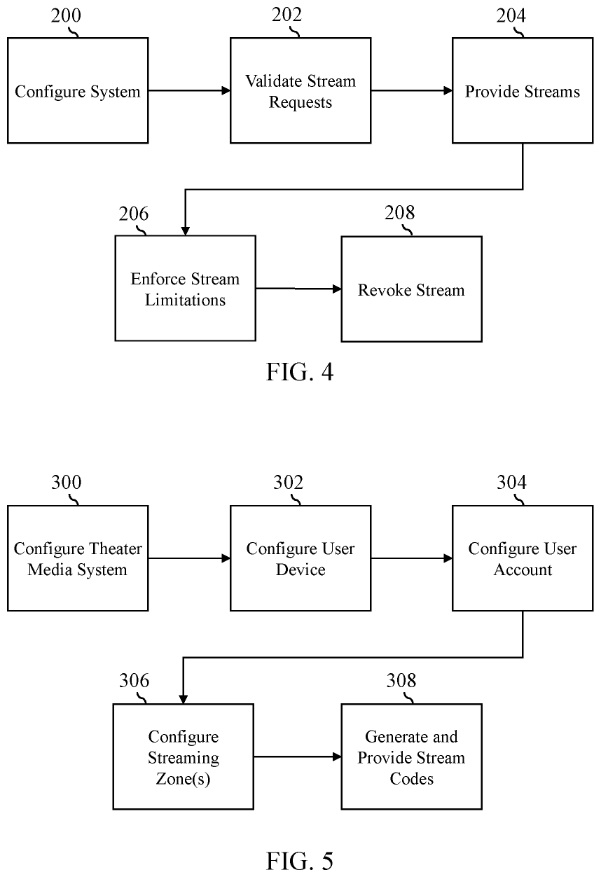

FIG. 4 a flowchart of a set of high-level steps that could be performed with a system such as that of FIG. 1 to provide shared media streaming with enforced limitations, as has been described above. The system may be configured (200) for particular theaters (130), and for particular user devices (104), which may include installing software on one or more devices, creating user accounts, configuring geofenced zones, and other configurations. The system may also receive and validate (202) stream requests from individual user devices (104), which may include verifying user information, user device locations, unique identifying information from stream codes, and other information. The system may also prepare and provide (204) shared media streams to one or more user devices (104) in response to requests for shared media streams. The system may also enforce (206) one or more stream limitations on shared media streams that have been allocated, which may include enforcing temporal and spatial limitations, as well as other limitations. The system may also (208) revoke shared media streams as they expire or are voluntarily ended, or are ended due to enforcement (206) of limitations, which may include creating and/or updating stored records related to the shared media stream allocation and user.

FIG. 5 is a flowchart of a set of steps that could be performed with a system such as that of FIG. 1 to configure an on demand media streaming system for use. This may include configuring (300) the theater media system (102) for use with the system, which will vary by implementation, but may include configuring additional wireless communication networks, and may include installing software on one or more devices of the theater media system (102) to enable access, manipulation, and distribution of film media stored by the theater media system (102). As one example, this may include configuring a software application to execute on a server of the theater media system (102), with such software being configured to receive requests for media (e.g., from the user device (104) or request server (108)), to select, create, or otherwise prepare the requested media (e.g., by selecting a portion of film media from a stored film media for a particular film), and to provide the requested media to the requesting user device (104) (e.g., by transmitting data to the user device (104) over a local wireless network).

A number of user devices (104) may also be configured (302), which may include installing the stream request interface (106) or otherwise accessing the stream request interface (106). User device configuration (302) may also include configuring the user device (104) as may be needed for enforcement (206) of stream limitations, which may include enabling a GPS feature, enabling a Wi-Fi communication feature, enabling a Bluetooth communication feature, or enabling or disabling other features of the user device (104) as will be explained in more detail below. A number of user accounts may also be configured (304), which may be performed via configured (302) user devices (104), and which may include providing user information, associating a user with a particular user device (104), providing payment information, associating a user with particular theaters (130), providing a username and/or password, and creation of user account records based thereon.

The system (100) may also be used to configure (306) one or more geofenced areas or geofencing rules to define the areas where streaming is allowed and disallowed, as illustrated by FIG. 3. This may include an employee of a theater or administrator of the system (100) moving about the theater with a user device (104) while the system (100) logs the devices position, and then associating each movement with a particular room or area that may then be allowed or disallowed. This may also include placement of location beacons (112) and storage of unique identifiers on the beacons and/or another device to indicate their location. This may also include establishing ambient lighting and/or ambient sound thresholds for one or more areas via a user device's (104) imaging and audio capture devices, which may be later used to determine whether ambient sound and/or lighting is suggestive of a screening room, or a restroom, for example.

The system (100) may also generate (308) and provide stream codes for audience members and users of the system (100). This may include configuring the theater media system (102) and/or theater point of sale system or other information system to generate and include optical codes (121) on tickets (120), or to distribute digital codes/tokens to be associated with digital tickets (120), or otherwise (e.g., codes may be distributed physically or digitally, including by printed code, or by communication of an electronic link or digital asset that may be viewed on a smartphone, via a web browser, or via another software application, for example). As each code is generated (308) and/or otherwise assigned to a particular user device (104) and/or film media screening, records reflecting that assignment and association may be created or updated to reflect that the code is now valid and usable, as well as any limitations or other characteristics of the code.

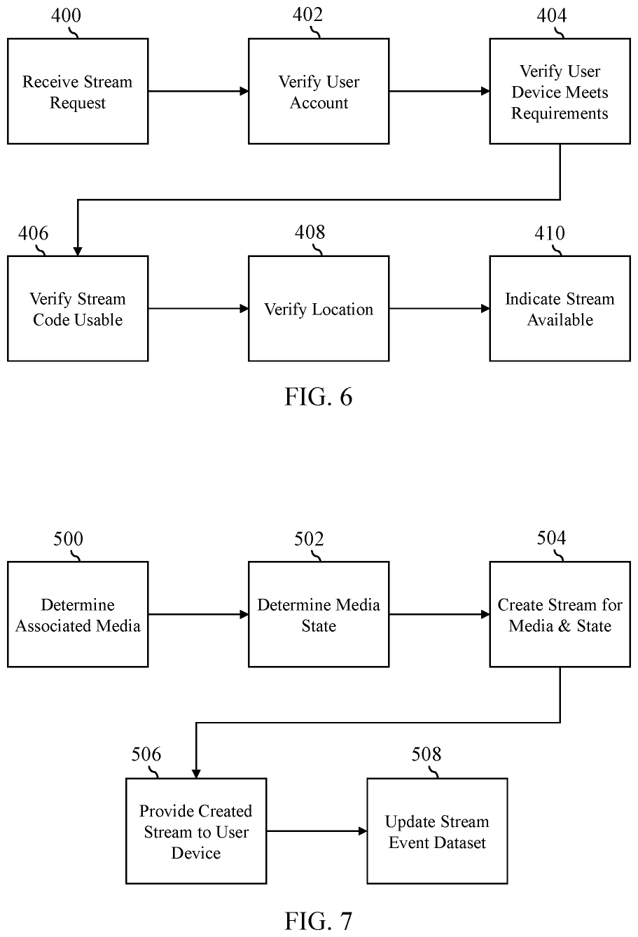

FIG. 6 is a flowchart of an exemplary set of steps that could be performed with a system such as that of FIG. 1 to receive and validate requests for media streams, which may occur after a user requests a stream and provides any required information (e.g., scanning of an optical code, providing a digital code or token) such as illustrated in FIG. 2. As stream requests are received (400) from user devices (104), the system may verify (402) that the user account is valid, which may include verifying authentication information, verifying that the requesting user device (104) is recognized as being associated with the account, verifying that the account has not been flagged or listed for prior abuse of the system (100), verifying that any required subscriptions or other settings are valid for the account, and otherwise.

The system may also verify (404) that one or more requirements for the user device (104) are met. This may include verifying that the user device (104) includes any required capabilities, and that such capabilities are enabled and usable, such as a GPS receiver, a Wi-Fi or Bluetooth transceiver, a headphone, headset, earbud, or other personal audio device. This may also include verifying an operating system version or status of the user device (104), a software version of the request interface (106), and ensuring that the user device (104) has not been tampered with (e.g., either the hardware, such as by attachment of an external video capture device, or the software, such as by jailbreaking or installation of a non-standard operating system). This may also include disabling some features of the user device while the request interface (106) is active, which may include disabling screen capture or screen recording features, limiting sound output from speakers, limiting screen brightness, limiting sound output only to a set of attached headphones, disabling sound entirely and enabling a closed captioning feature, or otherwise.

The system may also verify (406) that the stream code associated with the request is usable, which may include verifying that the provided code was generated and/or issued by the system, that the code hasn't been disabled due to exhaustion of a limited streaming time or expiration of the available time (e.g., such as where the live screening has ended), or a revocation of the code due to detected abuse. The system may also verify (408) the user device's location, which may include establishing an initial location of the user device (104) relative to any geofencing areas or other configured zones, using location determination methods such as those disclosed herein. The system may then indicate (410) via the request interface (106) that the shared media stream is available, and may indicate any additional action that the user must take to begin displaying the shared media stream (e.g., “Exit the screening room and your media will start playing”).

FIG. 7 is a flowchart of an exemplary set of steps that could be performed with a system such as that of FIG. 1 to provide media streams in response to requests, such as after a stream request has been validated (202) without issue. For each request that will be allocated a shared media stream, the system may determine (500) the media that is associated with the request, which may include identifying a particular film that the user is viewing based on the optical code information, digital code, or other unique identifying information provided with the request by searching a database or other dataset that associated generated codes with particular film screenings. The system may also determine (502) the current state of the associated media, which may include determining a time at which the screened film media is currently playing, relative to the film media's overall timeline (e.g., for a 90 minute long film, determining that the screening is currently at 42 minutes, 38 seconds elapsed). For example, this determination may be made by the system based upon a known current time and a stored schedule of screenings (e.g., as may be available to the request server (108)), or may be determined based upon an actual elapsed time of the screening regardless of its scheduled starting time (e.g., as may be available to the theater media system (102)).

The system may also create (504) or define a media stream based on the associated media and determined media state. This may include selecting, from a stored version of the associated media, a portion of the stored media based on the determined (502) media state, where the extent of the portion may be determined based upon a configured time limit for shared media streaming, or based upon a remaining duration of shared media streaming for a particular instance or code. Continuing the above example, where the screening has reached the 42 minute, 38 second mark, and a configured time limit for shared media streaming is 15 minutes, the system may create or define a shared media stream of 15 minute duration starting at the 42 minute, 38 second mark.

In some implementations, this may include creating a separate file, dataset, or data stream that includes only the associated portion of media (e.g., a file or data stream that includes only 15 minutes of content) and providing that entire file, or providing that data stream, to the user device (104) such that the request interface (106) will access and cause the shared media stream to play, and then delete or remove the file after revocation of the shared media stream.

In some implementations, this may not include the creation of any new files or datasets, and may instead include defining a period of time for which the user device (104) can access a common data stream of the film media (e.g., the system may provide a data stream of the film media for its entire duration, and each user request will give a particular user device (104) access to view media from that data stream within a defined time period). In either case, creation or definition (504) of the shared media stream may include some modifications to the shared media stream that are unique to a particular requester, which may include, for example, a watermark, overlay, audio tone, or other audible or visible output added to the shared media stream that is unique to the particular user device (104), which may aid in identifying a particular user device (104) from which screenshots or video recordings of the shared media stream may have been captured.

Once the shared media stream is created (504), defined, or otherwise prepared, it may be provided (506) to the requesting user device (104) as downloaded files or streaming media data, depending upon a particular implementation. As shared media streams are created and provided to user devices (104), the system update (508) or create stream event datasets for each shared media stream to indicate the content, time, recipient, and other characteristics of the shared media stream that has been allocated.

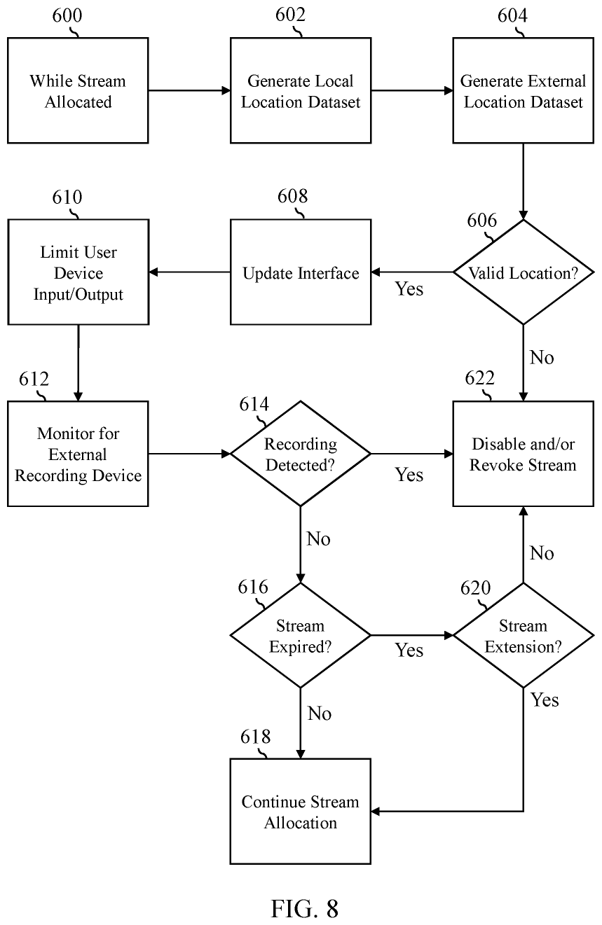

FIG. 8 is a flowchart of an exemplary set of steps that could be performed with a system such as that of FIG. 1 to enforce limitations for allocated streams once they are provided (204) to user devices (104). For each stream that is allocated, while that stream is allocated (600), the system may perform a number of enforcement actions on a schedule or based on the passage of time, or on a continuous or ongoing basis, for example. Different enforcement steps may be performed by one or more of the user device (104), the request server (108), the theater media system (102), or other devices.

The system may generate (602) a local location dataset using one or more sensors of the user device (104) (e.g., internal location sensors or features, imaging devices, audio capture devices), and may generate (604) an external location dataset using one or more sensors of the user device (104) and/or one or more external devices (e.g., location beacons (102), a global positioning satellite). The location dataset(s) may be analyzed in whole or in part to determine a location of the user device (104) relative to any geofenced areas or other configured zones where shared media streams are allowed or disallowed, and where the present location is determined to be a valid (606) location where streaming is allowed, the system (e.g., the request interface (106) and/or user device (104)) may enable shared media streaming and/or continue current shared media streaming. Where the current location is not valid (606) for shared media streaming, the system may disable (622) shared media streaming until a valid location is reached, or may revoke shared media streaming entirely.

The system may also update (608) the request interface (106) throughout shared media streaming, which may include updating the remaining time (124), updating the zone indicator (126) based on a recently determined location, or otherwise. The system may also reconfigure and/or prevent configuration of one or more features or settings of the user device (104), as has been described. This may include setting a maximum brightness of the display (e.g., to limit the distance at which the shared media stream can be easily viewed), setting a maximum volume level (e.g., to limit the distance at which the shared media stream can be easily heard), restricting audio output to an attached headphone or other device, disabling screen sharing or screen recording features, ensuring that a GPS feature or wireless communication feature is enabled, and other configurations. While these features may have been previously set or configured (e.g., upon first configuration, upon stream request), the user device (104) may disable further changes, or may monitor for the occurrence of any changes to required settings (e.g., and disable (622) streaming or re-configure the settings to match the requirements).

The system may also monitor (612) for the presence of any external recording devices, which may be coupled to the user device (104) via a USB connection or other interface, or that may be directed at the display of the user device (104) during shared media streaming. Detection of an external recording device directed at the display may include capturing images using a front-facing camera or imaging device of the user device (104) regularly during shared media streaming, and analyzing captured images (e.g., using object recognition, image recognition, or other machine vision processes to detect shapes that may be a lens or camera, or to detect reflections from a lens, or to detect and ensure that a user's face is positioned at the center of captured image rather than another object or device, etc.). Such analysis may be performed by the user device (104), the request server (108), the theater media system (102), or another system

Where a recording device is detected (614) (e.g., or where other enforcement checks indicate intentional tampering with device settings, or other suspect activity), the system may disable and/or revoke (622) the shared media stream. This may include ceasing display of the media via the user device (104), deletion of any downloaded media file, and revocation of access to any media stream. Similarly, where the shared media stream expires based on the time limit (124), the system may disable and/or revoke (622) the shared media stream. In some implementations, where the time limit (124) is near expiring, the user may be given an opportunity to extend the stream (620) by a limited amount of time by scanning additional optical codes (e.g., which may be provided as a customer service, or by scanning an optical code that is statically fixed to a surface within the concession area), or making additional selections and/or purchases via the request interface (106), for example. Where no stream extension occurs, the system may disable and/or revoke (622) the shared media stream.

Where the shared media stream passes all enforcement checks, and is not expired (616) or is otherwise extended (620), the stream allocation may continue, resulting in additional evaluations while the stream remains allocated (600).

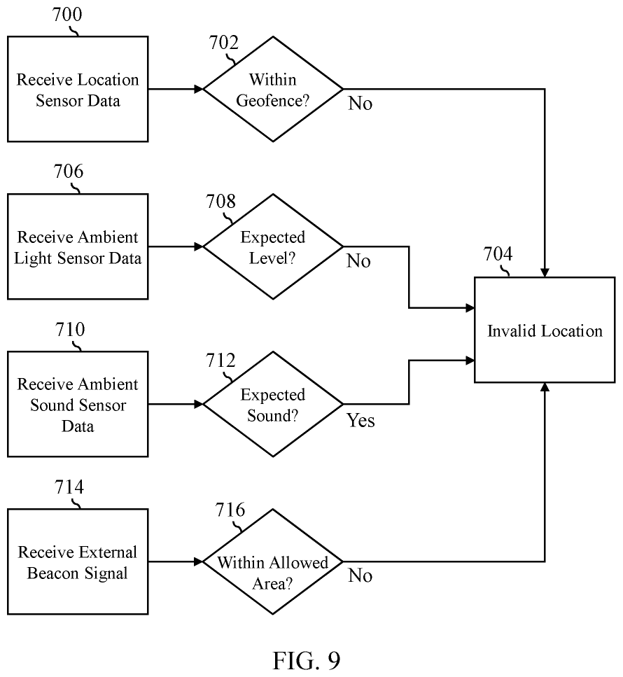

FIG. 9 is a flowchart of a set of steps that could be performed with a system such as that of FIG. 1 to determine a user device location, as has been described above. This may occur when registering a user device (104), requesting a shared media stream, or enforcing limitations, as has been described. As one example of location determination, the system (e.g., the user device (104)) may receive (700) location sensor data from a location sensor of the user device (104), which may be a GPS receiver, a Wi-Fi transceiver configured for Wi-Fi triangulation, or another location sensor or feature. The received (700) data may be evaluated against one or more configured geofenced areas (702) to determine whether the user device (104) is within an allowed or disallowed zone, and where it is determined to be in a disallowed zone, the system will determine that the location is invalid (704).

As another location determination, the system (e.g., the user device (104)) may receive (706) ambient light sensor data from an image capture device or a light sensor of the user device (104). The light sensor data may describe the magnitude, color, or other characteristics of light at a moment of time, or over a period of time. Where the magnitude of light, or other characteristics of light, are outside of an expected level or range (708) that indicates the user device (104) is not within a screening room, the system will determine that the location is invalid (704). This may include determining that the sensed light level is lower than that of a concession area or restroom, and matches the light level in a dark theater, or may include determining that a pattern of light over time exhibits a series of sudden changes in light that are characteristics of a film, but would not be found in a concession area or restroom.

As another location determination, the system (e.g., the user device (104)) may receive (710) ambient sound sensor data from an audio capture device of the user device (104). The audio sensor data may describe the magnitude, content, or other characteristics of audio at a moment of time, or over a period of time. Where the magnitude of the detected audio, or other characteristics of detected audio, are outside of an expected level or range (712) that indicates the user device (104) is not within a screening room, or where the detected audio content matches audio content that would currently be playing in the screening room, the system will determine that the location is invalid (704). This may include determining that the sensed audio is louder than that of a concession area or restroom, or may include determining that a pattern of sound detected over time exhibits a series of sudden changes that are characteristics of a film, but would not be found in a concession area or restroom. This may also include the system determining whether the captured audio matches the audio present in the screening room, which would suggest that the user device (104) is located in the screening room. As an example of the above, the theater management system (102) that stores the film media (e.g., the audio and video) may receive an audio sample captured by the user device (104), and may compare that against stored audio data to determine whether the ambient sounds captured by the user device include those presented as part of the film screening, which indicates that the user device (104) is still present within the screening room or nearby.

As another location determination, the system (e.g., the user device (104)) may receive (714) external communications from a location beacon (112) or other locally situated device indicating that the user device (104) is within a communicable proximity of those devices. Each location beacon (112) may be configured to provide self-identifying data, or self-locating data, that indicate where the detected beacon (112) is located, and that indicate the user device (104) is within a certain proximity of that location (e.g., this range may vary depending upon the particular location beacon (112), but between about 2 feet and about 10 feet). Where the received signals (714) indicate that the user device (104) is within communicable range of a beacon outside an allowed area (716), the system will determine that the location is invalid (704). As an example of the above, one or more location beacons (112) may be situated at exits from the theater building, and exits from each screening room, and the system may be configured to determine the user's location based upon communication between the user device (104) and those beacons that is indicative of movement. Other methods of location determination exist, and will be apparent to those of ordinary skill in the art in light of this disclosure.

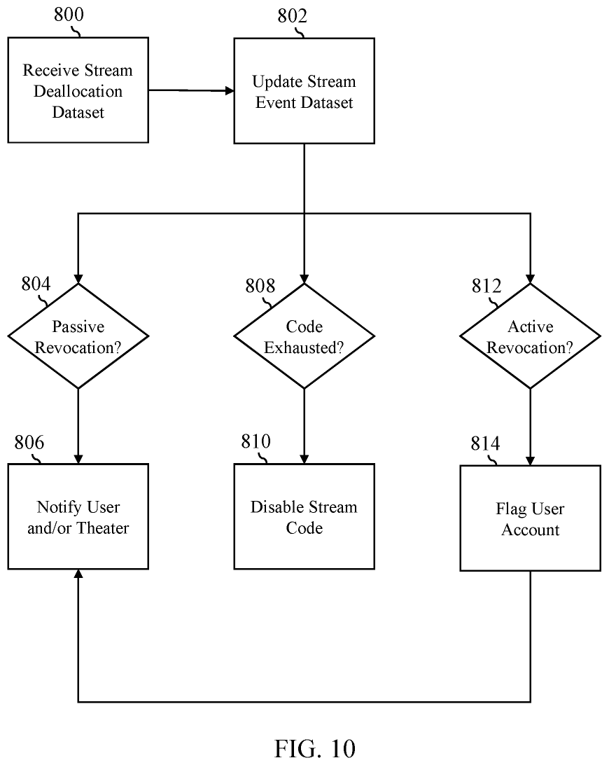

FIG. 10 is a flowchart of an exemplary set of steps that could be performed with a system such as that of FIG. 1 to revoke and close allocated streams one they expire, are voluntarily released by the user, or are revoked due to suspicious activity detected by the user device (104). When a stream is revoked (e.g., such as described in the context of FIG. 8), the system may receive (800) a stream deallocation dataset that describes the context, circumstances, and reason for revocation, and may also describe any remaining play time associated with the streaming code (e.g., where a code provides 15 minutes of shared media streaming, and only 8 minutes have been used). The system may then update (802) or create records associated with the streaming event, which may include recording usage of the streaming code, reasons for revocation of the stream, or other information generated by the steps described above.

Based on the records associated with the streaming event, the system may take additional steps related to revoking and closing the shared media stream. As an example, where revocation occurred because the used code is exhausted (808) (e.g., the full play time of the code has been used), the system may disable (810) the stream code so that future attempts to use the code will fail.

As another example, where revocation occurred due to a passive (804) or accidental misuse of the shared media stream, such as may occur where a user enters an area where streaming is disallowed, the system may notify (806) the user and/or theater personnel to indicate the reason the shared media stream was ended. User's may use such information to avoid disallowed areas in the future, while theater personnel may use such information to reconfigure or update geofencing configurations, or to confirm that geofencing configurations are functioning as intended.

As another example, where revocation occurred due to an active (812) or intentional misuse of the shared media stream, such as may occur where a user's attempt to record the shared media stream onto the user device (104) or with another device is detected, the system may flag (814) the user account and notify (806) the user and the theater personnel of the active attempt to misuse the system. Flagging (814) of a user account may disable the account for a period of time or permanently, and may additionally result in received and stored data that is associated with the user device (104) and user account that were misused being bundled into an audit dataset that may be used to further investigate the misuse where warranted.

While the system (100) has primarily been discussed in the context of movie theaters, it should be understood that the technology disclosed herein may also be applied for sporting events, concerts, classrooms, and in other contexts where a user may need to temporarily step away from a live event without missing any substantial portion of the event. As an example, where such an event is occurring live instead of being distributed as film media, the event may be recorded as it occurs by a camera at the venue, with recording being distributed to requesting user devices (104) as described above (e.g., the shared media stream may be provided via a local wireless network at the location).

It should be understood that any one or more of the teachings, expressions, embodiments, examples, etc. described herein may be combined with any one or more of the other teachings, expressions, embodiments, examples, etc. that are described herein. The following-described teachings, expressions, embodiments, examples, etc. should therefore not be viewed in isolation relative to each other. Various suitable ways in which the teachings herein may be combined will be readily apparent to those of ordinary skill in the art in view of the teachings herein. Such modifications and variations are intended to be included within the scope of the claims.

Having shown and described various embodiments of the present invention, further adaptations of the methods and systems described herein may be accomplished by appropriate modifications by one of ordinary skill in the art without departing from the scope of the present invention. Several of such potential modifications have been mentioned, and others will be apparent to those skilled in the art. For instance, the examples, embodiments, geometrics, materials, dimensions, ratios, steps, and the like discussed above are illustrative and are not required. Accordingly, the scope of the present invention should be considered in terms of the following claims and is understood not to be limited to the details of structure and operation shown and described in the specification and drawings.

1. A system comprising:
(a) a stream request server in communication with a database configured to store a plurality of stream code datasets, wherein each stream code dataset comprises a stream code, an event identifier that describes a presentation of an event, a set of usage data usable to validate the stream code, and a set of location data usable to validate a streaming location;
(b) an event media system configured to receive and store multimedia content for presenting the presentation of the event to an audience;
(c) a stream request interface configured to be executed by a user device to receive inputs from and provide output to a user of the user device;
wherein:
(i) the stream request interface is configured to receive the stream code from the user device and provide the stream request server with the stream code and a current location based on a location of the user device;
(ii) the stream request server is configured to:
(A) identify a stream code dataset of the plurality of stream code datasets that is associated with the stream code;
(B) determine whether the stream code is valid based on the set of usage data for the stream code dataset and a determination of whether the presentation of the event is presently occurring based on the event identifier;
(C) in response to determining that the stream code is valid, cause the event media system to provide the user device with a portion of multimedia content associated with the event based on an elapsed time of the presentation;
(iii) the stream request interface is configured to verify that the current location of the user device is valid for presentation of the portion of multimedia content based on the set of location data, and to only present the portion of multimedia content via the user device when the current location is valid and a stream time limit associated with the set of usage data has not been exceeded.

2. The system of claim 1, wherein the stream request interface is further configured to, when presenting the portion of multimedia content via the user device:
(a) cause the user device to display a visual component of the portion of multimedia content; and
(b) cause the user device to display a time indicator with the visual component that describes a remainder of the stream time limit.

3. The system of claim 2, wherein the stream request interface is further configured to, when presenting the portion of multimedia content via the user device, determine a zone warning indicator based on the current location of the user device, wherein the zone warning indicator describes the proximity of the user device to a location that is not valid for presentation of the portion of multimedia content, and cause the user device to display the zone warning indicator with the visual component.

4. The system of claim 1, wherein the set of location data comprises a set of location coordinates, and the stream request interface is configured to determine the current location based on a location sensor of the user device that generates location data corresponding to the set of location coordinates.

5. The system of claim 1, wherein the stream request interface is configured to receive the stream code from an optical reader of the user device in response to the optical reader scanning an optical representation of the stream code.

6. The system of claim 5, wherein the optical representation of the stream code comprises a printed ticket for the presentation of the event on which the optical representation is printed.

7. The system of claim 1, wherein the stream request interface is further configured to, when presenting the portion of multimedia content via the user device:
(a) cause a display of the user device to display a visual component of the portion of multimedia content; and
(b) prevent a speaker of the user device from emitting an audible component of the portion of multimedia content.

8. The system of claim 1, wherein the stream request interface is further configured to, when presenting the portion of multimedia content via the user device:
(a) receive a set of ambient data from one or more sensors of the user device; and
(b) verify that the current location of the user device is valid for presentation of the portion of multimedia content based on the set of location data and the set of ambient data.

9. The system of claim 8, wherein the set of ambient data comprises one or more of:
(a) a set of light sensor data, wherein the stream request interface is configured to determine that the current location of the user device is valid based on the set of light sensor data falling within a configured range of ambient light; or
(b) a set of sound sensor data, wherein the stream request interface is configured to determine that the current location of the user device is valid based on the set of sound data falling within a configured range of ambient sound.

10. The system of claim 1, wherein the presentation of the event is a screening of a film at a theater.
